(19) United States
(12) Patent Application Publication
(10) Pub. No.: US 2024/0246032 A1
(43) Pub. Date: Jul. 25, 2024

(54) PROCESS CONTROL FOR MEMBRANE-BASED SEPARATIONS

(71) Applicant: COMPACT MEMBRANE SYSTEMS, INC., Newport, DE (US)

(72) Inventors: Kenneth J. PENNISI, Bear, DE (US); Kenneth Evan LOPRETE, Cherry Hill, NJ (US)

(21) Appl. No.: 18/294,993

(22) PCT Filed: Aug. 2, 2022
(86) PCT No.: PCT/US2022/039112

§ 371 Date: Feb. 2, 2024

Related U.S. Application Data
(60) Provisional application No. 63/229,824, filed on Aug. 5, 2021.

(51) Int. Cl. B01D 61/22; B01D 61/58

(52) U.S. Cl. CPC B01D 61/22; B01D 61/58; B01D 2311/246

(57) ABSTRACT

Provided herein are systems and methods for controlling a membrane-based separation process. The systems and methods can comprise, by one or more computing devices: receiving a product concentration, which product is produced by a process comprising a membrane separation, which process is operated at a first set of operating conditions; optionally calculating a membrane performance parameter based at least in part on the first set of operating conditions; calculating a second set of operating conditions based at least in part on the membrane performance parameter and a model of the process, such that operation of the process at the second set of operating conditions is expected to produce the product within a desired concentration range; and communicating the second set of operating conditions to the process.

### CROSS REFERENCE TO RELATED APPLICATIONS

This application claims the benefit of priority to U.S. Provisional Patent Application No. 63/229,824, filed on Aug. 5, 2021.

### BACKGROUND

Control of product compositions in many chemical separation processes can pose a difficult problem for process control systems. Product compositions are not directly controlled, but rather are controlled by adjusting other process variables. Although adjustment of the independent variables of the process may be simple, maintaining product streams in the desired composition range is often not simple. Complex separation processes can have slow process dynamics and product stream compositions are often measured by gas chromatography, which is also a slow and discontinuous process. It can be difficult for proportional-integral-derivative (PID) controllers to keep product stream compositions within required limits under these circumstances. In addition to inherent lag times in the process, control systems must respond to the impacts of significant changes in feed stream composition and variations in other variables such as temperature, which can be caused by changes in the upstream process or even changes in ambient conditions.

In the case of separation processes utilizing membranes, the situation is further complicated by changes in membrane performance parameters that impact separation performance. Such changes typically are a result of physical changes in the membrane that occur over time with use. Although these property changes can occur at a slow and fairly constant rate for most of the life of a membrane, the initial changes can occur relatively rapidly and at a declining pace. In the case of facilitated transport membranes, membrane performance parameters are also often a function of operating conditions. Regardless of the cause of membrane performance parameters variations, it can be difficult to compensate for them with a simple control scheme, such as PID control, particularly given the characteristically slow process dynamics and slow process data collection of membrane-based separation processes.

### SUMMARY

Disclosed herein is a control system and a control algorithm that can be applied to control the compositions of product streams derived from a separation process that utilizes membranes as a unit operation for the separation of chemical mixtures. In an aspect, the process control approach utilizes membrane models to predict separation performance under varying operating conditions, which can provide a more effective means of controlling product stream compositions by “intelligent specification” of key process variables.

In an aspect, provided herein is a method for controlling a membrane-based separation process. The method can comprise, by one or more computing devices: receiving a product concentration, which product is produced by a process comprising a membrane separation, which process is operated at a first set of operating conditions; optionally calculating a membrane performance parameter based at least in part on the first set of operating conditions; calculating a second set of operating conditions based at least in part on the membrane performance parameter and a model of the process, such that operation of the process at the second set of operating conditions is expected to produce the product within a desired concentration range; and communicating the second set of operating conditions to the process.

In another aspect, provided herein is a system for controlling a membrane-based separation process. The system can comprise: a membrane module of a separation process, which separation process is configured to enrich a product; a detector configured to measure a concentration of the product; a sensor configured to measure a process parameter associated with the process; a controller configured to control an operating condition associated with the process; and a computing device. The computing device can be configured to: receive a product concentration from the detector when the process is operated at a first set of operating conditions; optionally calculate a membrane performance parameter based at least in part on the first set of operating conditions; calculate a second set of operating conditions based at least in part on the membrane performance parameter and a model of the process, such that operation of the process at the second set of operating conditions is expected to produce the product within a desired concentration range; and communicate the second set of operating conditions to the controller.

In some embodiments, the membrane performance parameter is calculated.

In some embodiments, the membrane performance parameter is fixed.

In some embodiments, the membrane performance parameter is capable of being adjusted.

In some embodiments, process data is also received and used at least in part to calculate the membrane performance parameter.

In some embodiments, the process data comprises a temperature, a pressure, a flow rate, or any combination thereof.

In some embodiments, the operating conditions comprise a valve setting, a pressure set point, a temperature set point, or any combination thereof.

In some embodiments, the membrane performance parameter comprises a permeance, a selectivity, or any combination thereof.

In some embodiments, the process comprises a plurality of membranes, and a membrane performance parameter is calculated for each of the plurality of membranes.

In some embodiments, the process comprises a plurality of membranes, and a composite membrane performance parameter is calculated for the plurality of membranes as a group.

In some embodiments, the model of the process includes an active membrane area for each membrane or group of membranes in the process.

In some embodiments, the membrane performance parameter is predicted at least in part (i) based on a set of operating conditions and (ii) based on the received process data.

In some embodiments, a correction factor is calculated and used to adjust the second set of operating conditions.

In some embodiments, the membrane performance parameter is predicted at least in part based on a set of operating conditions.

In some embodiments, the set of operating conditions are calculated by a separation model.

In some embodiments, the membrane performance parameter is associated with changes in a set of operating conditions.

In some embodiments, the membrane performance parameter is calculated using a power law function fit to the operating conditions and/or the received process data.

In some embodiments, the membrane performance parameter is calculated based at least in part on the received process data and the membrane area.

In some embodiments, the received process data includes temperatures, pressures, compositions, and flow rates of any stream entering or leaving the membrane.

In some embodiments, the membrane performance parameter is associated with aging of the membrane.

In some embodiments, the membrane performance parameter is calculated based at least in part on transport rate equations for a component in a process stream, a mass balance, and a predicted pressure drop.

In some embodiments, the transport rate equations are averaged or integrated over the membrane surface, optionally using a transport driving force calculated using a log-mean or finite element method.

In some embodiments, the second set of operating conditions is calculated based at least in part using transport rate equations for a component in a process stream, a mass balance, and a predicted pressure drop.

In some embodiments, a plurality of membrane separations are calculated simultaneously.

In some embodiments, the membrane performance parameter and/or the second set of operating conditions are not calculated if the received product concentration is within the desired concentration range.

In some embodiments, the systems and methods further comprise, prior to calculating a membrane performance parameter, calculating a product composition error, which error is associated with a difference between the received product concentration and a desired product concentration.

In some embodiments, the membrane performance parameter is not calculated if the product composition error is less than a threshold error.

In some embodiments, the second set of operating conditions are calculated based at least in part on proportional adjustment of the first set of operating conditions if the composition error is less than the threshold error.

In some embodiments, the systems and methods further comprise, (i) calculating a second membrane performance parameter based at least in part on the second set of operating conditions and (ii) calculating a third set of operating conditions based at least in part on the second membrane performance parameter and the model of the process.

In some embodiments, the systems and methods further comprise, iteratively calculating new membrane performance parameters and new sets of operating conditions, based on results of a previous iteration, until the membrane performance parameter converges on a value.

In some embodiments, the systems and methods further comprise, communicating to the process, the operating conditions that are calculated when the membrane performance parameter converges.

In some embodiments, the product concentration is measured by gas chromatography.

In some embodiments, the membrane separation comprises a facilitated transport membrane.

In some embodiments, the membrane performance parameters depend at least in part on the process conditions.

In some embodiments, the membrane performance parameters change over a lifetime of the membrane.

In some embodiments, the second set of operating conditions are communicated to a programmable logic controller (PLC).

In some embodiments, the PLC changes the position of a valve, changes a pressure, or changes a temperature of a portion of the process.

In some embodiments, the process data is received from the PLC.

### DESCRIPTION OF THE FIGURES

The accompanying figures are included to provide a further understanding of the invention, are incorporated in, and constitute a part of this specification. Corresponding reference characters indicate corresponding parts throughout the view of the figures and are not to be construed as limiting the scope of the invention in any manner. Furthermore, the figures are not necessarily to scale. Some features may be exaggerated to show details of particular components. The figures illustrate embodiments of the invention and together with the description serve to explain the principles of the invention. Therefore, specific structural and functional details disclosed herein are not to be interpreted as limiting.

FIG. 1 shows an example of a one-stage membrane process.

FIG. 2 shows an example of a two-step membrane process.

FIG. 3 shows an example of a two-stage membrane process.

FIG. 4 shows an example of a two-step, two-stage membrane process.

FIG. 5 shows an example of the basic architecture of the control system hardware described herein as well as connectivity between the components.

FIG. 6 shows an example of a flow diagram of the composition control algorithm described herein, e.g., as applied by a computer to calculate the required setpoint changes of the independent variables to maintain the compositions of the products streams in the desired ranges.

FIG. 7 shows another example of a flow diagram of the composition control algorithm described herein.

FIG. 8 shows an example of the inputs and outputs of the OMPPM.

FIG. 9 shows an example of the inputs and outputs of the EMPPM.

FIG. 10 shows an example of the inputs and outputs of the separation model.

### DESCRIPTION

The process control system described herein can be used for control of product stream compositions from chemical separation processes that utilize membrane unit operations. The control system can be applicable to any kind of membrane (e.g., zeolite, molecular sieve, mixed matrix, organo-silica, facilitated transport, etc., including composites or combinations thereof). The membranes can also be used in any kind of process (e.g., pharmaceuticals, petrochemicals, industrial gases, emission control, etc.), including for the separation of gases, liquids, or combinations thereof.

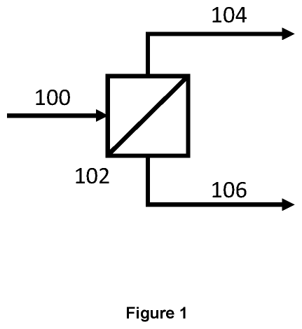

The process control system described herein can be used for control of any kind of membrane system design (e.g., single stage, multistage, multistep, or a combination of multistage and multistep designs). For example, FIG. 1 shows a one-stage membrane process where a feed stream 100 is separated by a membrane 102 into a retentate stream 104 and a permeate stream 106.

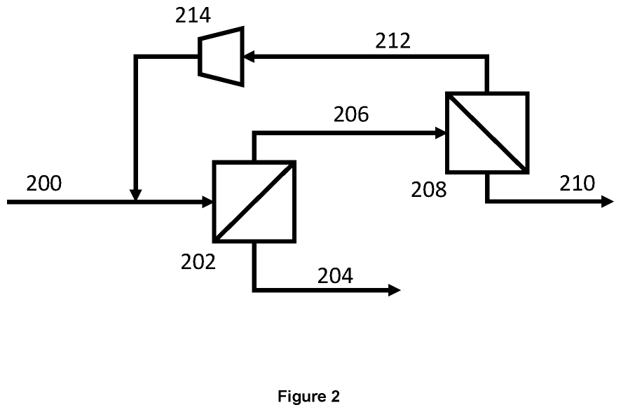

FIG. 2 shows an example of a two-step membrane process where the feed stream 200 goes to a first membrane 202 that produces a permeate 204 and a retentate 206, which is used as the feed to a second membrane 208. The second membrane produces a retentate 210 and a permeate 212 that is compressed in a compressor 214 and recycled to the first membrane 202.

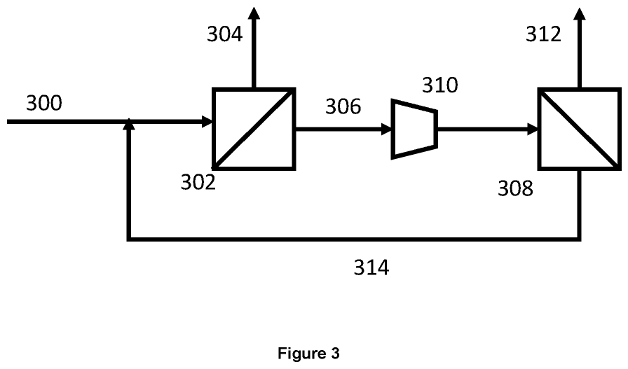

FIG. 3 shows an example of a two-stage membrane process where the feed stream 300 goes to a first membrane 302 that produces a retentate 304, and a permeate 306 which is used as the feed to a second membrane 308. The permeate can be compressed in a compressor 310. The second membrane produces a permeate 312 and a retentate 314 that is recycled to the first membrane 302.

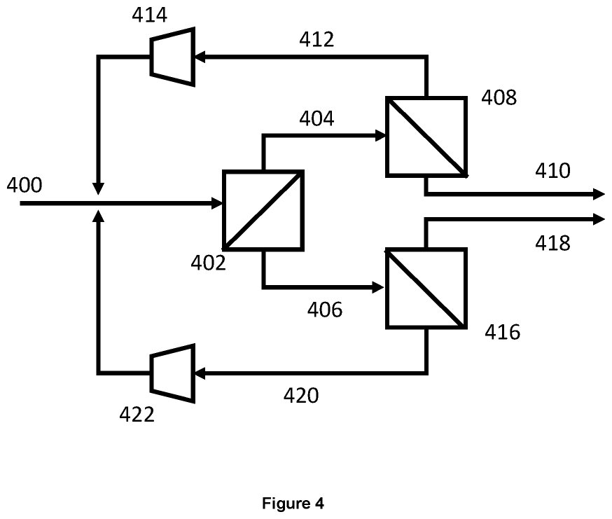

FIG. 4 shows an example of a two-step, two-stage membrane process where the feed stream 400 goes to a first membrane 402 that produces a retentate 404 and a permeate 406. The retentate can go to a second membrane 408 that produces a retentate 410 and a permeate 412, which is recycled (optionally following compression 414) to the first membrane 402. The permeate from the first membrane 406 can be fed to a third membrane 416 that produces a permeate 418 and a retentate 420, which is recycled (optionally following compression 422) to the first membrane 402.

The control system hardware can comprise a computer, a programmable logic controller (PLC), hardware connected to the process to monitor key process parameters, and hardware connected to the process to adjust key process parameters. The computer may be any kind of computer having the following features: data storage, input/output ports for communicating with a means for measuring product composition such as a gas chromatograph (GC), and a data communications network. Software can be configured to execute the composition control algorithm described herein. The PLC may be any kind of PLC, e.g., that is capable of communicating with the computer over a data communications network, accepting process data from instrumentation embedded in the process, and sending command signals to process control devices embedded in the process, such as valves that regulate flow rate or pressure. Flow rates, temperatures and pressures can be the primary independent variables that may be adjusted to influence product stream compositions.

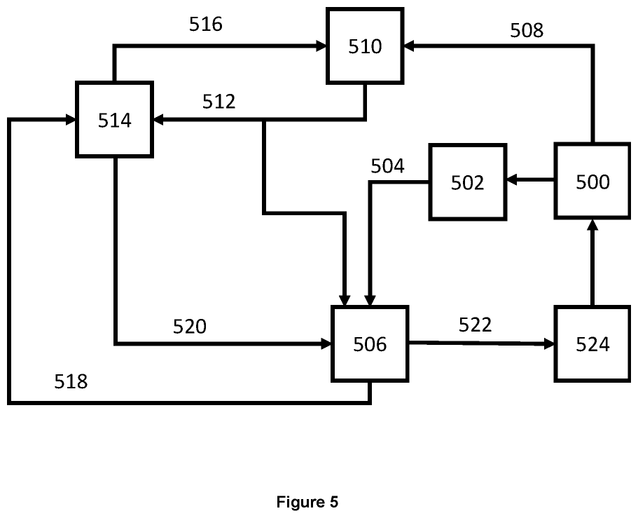

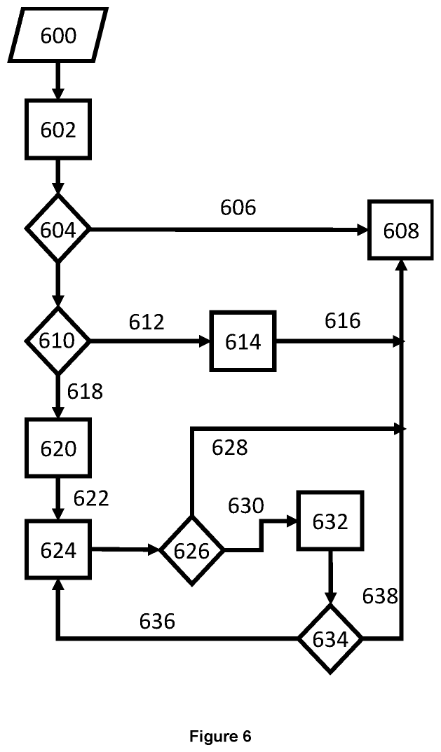

FIG. 5 shows an example of the basic architecture of the control system hardware and connectivity between the components described herein. The computer, programmable logic controller (PLC), gas chromatograph (GC), various sensors, and automated controls make up the control system hardware. The primary function of the computer is to store and execute the composition control algorithm illustrated in FIG. 6 and transmit the calculated setpoint changes for the independent process variables to the PLC. The computer also receives process stream composition data from the GC and other process stream parameters from the PLC. It uses the data in the execution of the composition control algorithm. The computer may also transmit commands to the GC. The primary purpose of the PLC is to receive process data from sensors on the process and transmit command signals to automated control components on the process. It may also receive composition data from the GC. The GC is a key data collection component that provides a means of process stream composition analysis. The GC may include its own automated sample collection apparatus that provides a means of automatically collecting and analyzing samples from multiple process streams at a specified frequency. Various sensors connected to the process continuously transmit process data to the PLC. Typically, essential process data includes stream temperatures, pressures, and mass flow rates. Automated controls accept command signals from the PLC and act on the process to adjust/maintain temperatures, pressures, and flow rates. These variables then influence the product stream compositions.

In more detail, FIG. 5 shows membrane separation process 500 having one or more sensors 502 (e.g., measuring mass flow, pressures, temperatures, or any combination thereof at various points of the process). The sensors can produce process data 504 that is input to a programmable logic controller (PLC) 506. Samples 508 can also be taken from the process (e.g., of the product and/or at various intermediate points of the process). The composition of the samples can be analyzed by any suitable means, such as a gas chromatograph 510 to produce process stream compositions 512. A computer 514 can send command or control signals 516 to the GC (e.g., to determine sampling frequency). The product stream compositions 512 can be communicated to the computer 514 and/or to the PLC 506. Additional information 518 such as the process data can be input to the computer (either directly, or through the PLC as shown here). The algorithm described herein can be computed in the computer to produce process set-points 520, which can be communicated to the PLC. Finally, the PLC can transform the set-points into command signals 522 for the automated controls 524, which adjust the process 500 to desired set points (i.e., as determined by the method described herein).

Other variations of the hardware configuration can also be employed. For example, the composition measurement module (e.g., GC) can communicate composition data to the PLC, which can then pass the data to the computer. Furthermore, a sample collection command signal to the composition measurement module can be transmitted by the PLC rather than the computer. The hardware connected to the process can include a composition measurement module, pressure sensors, temperature sensors, flow meters, automated control valves, and automated heat input devices. As described herein, the composition measurement module can include built in control and sample analysis hardware and an automated system for collection and analysis of samples from various streams in the process. The automated sample system can collect samples at regularly scheduled times or samples may be collected on demand by sending a command signal to the composition measurement module.

The software for the control system can execute the composition control algorithm described herein. The composition control algorithm can utilize process data, such as temperatures, pressures, and flow rates, from the PLC. It can also utilize composition data from the composition measurement module (e.g., GC). The algorithm evaluates a stream composition error. If the error is small enough to be acceptable, no action is taken and the setpoints for the independent variables are maintained at their current values. In some embodiments, for moderate composition errors, a simple proportional control algorithm may be used to calculate updated setpoints for the independent variables. The definition of what would constitute a moderate error would differ from process to process. For larger composition errors, the process data can be used to calculate the current membrane performance parameters, permeances and selectivities, i.e., for each membrane stage and/or membrane step of the process. Since each stage or step may contain multiple membrane units or cartridges, the calculated membrane performance parameters can be a representative average of the performance parameters of all the membranes in each stage or step. These calculated membrane performance parameters can then be used in the membrane separation model to calculate new independent variable setpoints required to obtain the target product compositions. The separation model can be configured to mimic the performance of the particular design employed in the process. For example, if the process to be controlled is a two-step-two-stage membrane system, the separation model would be configured specifically to predict the separation produced by that particular system design. In addition, within the model, the active membrane area in each step or stage would be matched to the actual values used in the process. An iterative calculation loop can be utilized to adjust the membrane performance parameters for the new operating conditions, e.g., for facilitated transport membranes. Once the iterative calculations are completed, the updated setpoints can be transmitted to the PLC, which then sends command signals to the process controls. Following changes in setpoints and after sufficient time has elapsed for the process to reach steady state, the computer can send a signal for the composition measurement module to collect another set of samples. Alternatively, the composition measurement module can be programmed to collect and analyze samples on a continuous basis as rapidly as desired.

FIG. 6 is an example of a flow diagram of the composition control algorithm applied by the computer to calculate the required setpoint changes of the independent variables to maintain the compositions of the products streams in the desired ranges. The core elements of the composition control algorithm are the dynamic membrane performance parameters models and the separation model. The dynamic membrane performance parameters models are used to calculate the key membrane performance parameters at the current operating conditions. These calculated membrane performance parameters are then used in the separation model to calculate new setpoints for the independent variables to bring the product stream compositions back into the desired ranges. There are two components to the dynamic membrane performance parameters models. These are the observed membrane performance parameters model (OMPPM) and the empirical membrane performance parameters model (EMPPM). For facilitated transport membranes in particular, an iteration loop utilizing the EMPPM can be implemented to adjust the membrane performance parameters for the impact of changes in the process parameters. A less rigorous control subroutine can be implemented within the composition control algorithm as an alternative setpoint adjustment method. This subroutine would be called under specific circumstances where the more rigorous method is not required.

There can be at least two components to the dynamic membrane performance parameters models. The first component of the dynamic membrane performance parameters models is referred to herein as the observed membrane performance parameters model (OMPPM). It can be used to calculate observed membrane performance parameters from the known and measured parameters of the process. These parameters can include pressures, temperatures, compositions and flow rates of process streams entering or leaving the membranes, and the membrane areas. The second component of the membrane performance parameters model predicts membrane performance parameters at the updated operating conditions selected by the separation model. These membrane performance parameters predictions can be based on an empirical performance parameters model for the particular type of membranes used in the process, e.g., for facilitated transport membranes when significant setpoint changes for the independent process variables are required. This component of the dynamic membrane performance parameters models is referred to herein as the empirical membrane performance parameters model (EMPPM). A coordinate transformation may be applied to the empirical membrane performance parameters model to bring it into agreement with the performance parameters calculated from the OMPPM.

In more detail, FIG. 6 shows an example of the process control algorithm described herein. Process data 600 can include temperatures, pressures, and flow rates, and stream compositions. A product composition error can be calculated 602, and determined 604 if within acceptable limits. If the error is within acceptable limits 606, the current set-points on the PLC 608 can be maintained. If the error is not within acceptable limits, it can be determined 610 whether the error is large or small. The threshold of what is a small or large error can vary between processes and set by the user based upon experimentation or experience operating the process. If the error is small 612, a simple proportional adjustment subroutine 614 can be used to update the process flow and/or pressure set-points 616 and be communicated to the PLC. If the error is large 618, the process data can be sent to the OMPPM 620. However, the determination whether the error is large or small is optional, and in some cases, the process data is sent to the OMPPM for any error outside the acceptable limit. The OMPPM can produce permeance and selectivity data 622 that is sent to the separation model 624. The algorithm can then determine 626 if there is an EMPPM for the membranes. If not, the updated process flow and other set points 628 can be communicated to the PLC. If yes, the updated process flow and other set points 630 can be communicated to the EMPPM 632. The output of the EMPPM includes a new set of membrane performance parameters. The algorithm can then determine 634 if the new set of membrane performance parameters differ significantly from the prior set. If yes, an iteration loop 636 can be established that provides the new set of membrane performance parameters to the separation model 624 for a refined calculation. If not 638, the updated process flow and other setpoints can be sent to the PLC 608. The dynamic membrane performance parameter models (DMPPM) can include the OMPPM 620 and the EMPPM 632.

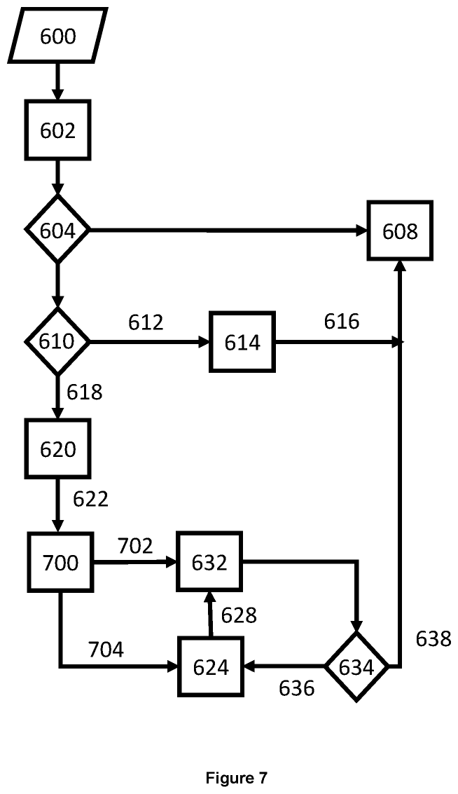

FIG. 7 shows another example of the process control algorithm described herein where like numbered elements represent like elements corresponding to FIG. 6. There is an EMPPM in FIG. 7, but if there were not an EMPPM, the performance and selectivity data from the OMPPM would simply be sent to the separation model, with the resulting updated process flow and other set-points sent to the PLC. Compared with FIG. 6, correction factors 700 are calculated as shown in FIG. 7 to match EMPPM performance parameters to OMPPM parameters. These correction factors 702 are applied to the EMPPM 632 and the permeance and selectivity data 704 is applied to the separation model 624. As for the case in FIG. 6, in the case in FIG. 7, the separation model 624 calculates updated process flow and other set-points 628 and provides them to the EMPPM 632. The output of the EMPPM includes a new set of membrane performance parameters. The algorithm can then determine 634 if the new set of membrane performance parameters differ significantly from the prior set. If yes, an iteration loop 636 can be established that provides the new set of membrane performance parameters to the separation model 624 for a refined calculation. If not 638, the updated process flow and other setpoints can be sent to the PLC 608.

As described herein, the OMPPM can utilize process data to calculate the membrane performance parameters. The OMPPM can account for changes in membrane performance, e.g., due to aging. Regardless of the separation process design (e.g., single stage or multistage), each bundle of membrane cartridges receiving a particular inlet stream can be analyzed as a single membrane unit that is independent of any other membrane stages or steps in the overall process. The performance parameters of each unit can be calculated from the process variables that are measured for the process streams (both into and out of the unit), pressures, compositions, flow rates, and temperatures. The OMPPM can include transport rate equations for each component in the process stream, a total mass balance, component mass balances, and equations for pressure drop. Because the transport rate of any given component can vary with position in the membrane (e.g., due to changes in composition and consequently driving force), the transport rate calculation can account for this (e.g., either by averaging or integration over the membrane surface). This may be accomplished with transport driving force calculations of any type ranging from simple, such as log-mean, to more rigorous, such as finite element. However, the basic equation for the transport rate of any component across the membrane at any given location is the following, where for ideal gas mixtures the Driving Force is the partial pressure difference:

$$Flux Across the Membrane = Permeance \times Driving Force$$

Any suitable transport rate equation can be used. One way to calculate an area averaged partial pressure difference for a given component is as the log mean partial pressure difference which may be expressed as:

$$( ( {P}^{R} \times r - {P}^{S} \times s ) - ( {P}^{F} \times f - {P}^{P} \times p ) ) / ln ( ( {P}^{R} \times r - {P}^{S} \times s ) / ( {P}^{F} \times f - {P}^{P} \times p ) )$$

In this equation: P^{R}=retentate pressure; P^{S}=sweep gas or closed end pressure; P^{F}=membrane feed pressure; P^{p}=permeate pressure; r=retentate mole fraction of component i; s=sweep mole fraction of component i; f=feed mole fraction of component i; and p=permeate mole fraction of component i. Any suitable method of calculating the closed end composition and pressure can be used (e.g., if no sweep gas is present).

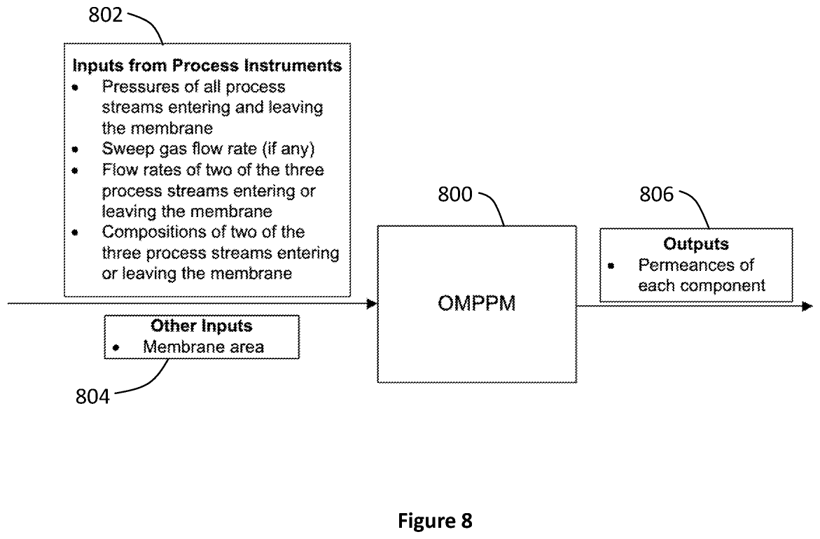

In summary, FIG. 8 shows an example of the inputs and outputs of the OMPPM 800. The inputs 802 comprise inputs from the process instruments, including pressures of all process streams entering and leaving the membrane, sweep gas flow rate (if any), flow rates (e.g., of two of the three) of the process streams entering or leaving the membrane, and compositions (e.g., of two of the three) of the process streams entering or leaving the membrane. Additional inputs 804 can include the membrane area. Finally, the output 806 can include permeances for each of the chemical components. The OMPPM can be applied at each membrane stage or step.

The EMPPM can utilize data from the separation model to calculate updated membrane performance parameters. One purpose of the EMPPM is to account for changes in membrane performance resulting from changes in operating conditions. This can be particularly useful for membranes that have performance that varies significantly with process conditions, such as facilitated transport membranes. The input data to the model can be the feed stream flow rate, feed pressure, and feed composition as calculated by the separation model. Additional input parameters may be included in the model for greater generalization and/or improved data fit. Additional parameters may include temperature of the feed or leaving process streams, pressures of the leaving process streams, or composition of the leaving process streams. Since the models are empirical and based on test data, the equations can be of any form that provides a good fit to the data. The following is an example of a set of power function equations for a facilitated transport membrane used to separate a two-component mixture of olefin and paraffin gases. For this particular set of equations to hold true, the membrane should be fully humidified.

$$Permeance = 83 \times {( Flow Parameter )}^{0.1624} \times {( Partial Pressure )}^{- 0.3747}$$

$$Selectivity = 52.96 \times {( Flow Parameter )}^{0.1753} \times {( Total Pressure )}^{- 0 \text{.5568}} \times {( Mole Fraction )}^{- 0.1518}$$

Where in these equations, Flow Parameter is flow rate of the feed stream per unit area of membrane, Partial Pressure is partial pressure of olefin in the feed stream, Total Pressure is the total pressure of the feed stream, and Mole Fraction is the dry basis mole fraction of olefin in the feed stream.

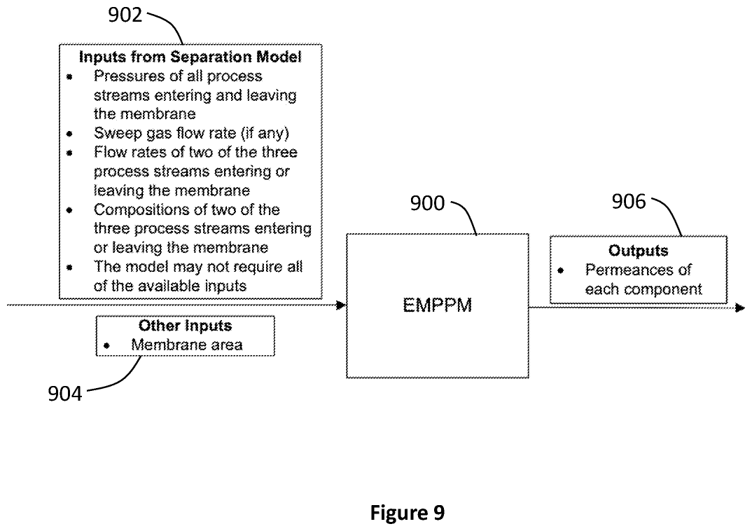

In summary, FIG. 9 shows an example of the inputs and outputs of the EMPPM 900. The inputs 902 comprise inputs from the separation model, including pressures of all process streams entering and leaving the membrane, sweep gas flow rate (if any), flow rates (e.g., of two of the three) of the process streams entering or leaving the membrane, and compositions (e.g., of two of the three) of the process streams entering or leaving the membrane. Additional inputs 904 can include the membrane area. Finally, the output 906 can include permeances for each of the chemical components. The EMPPM can be applied at each membrane stage or step.

In some instances, the separation model uses the same equations as the OMPPM plus additional mass balances for the overall separation process. In some cases, instead of solving for the membrane performance parameters (which are inputs in this model), the model solves for the operating conditions required to achieve the desired product stream compositions. The separation model can also differ from the OMPPM in that various membrane stages and steps can be solved simultaneously rather than independently. In some cases, intermediate stream compositions are not measured, but calculated by the model so the separation occurring at one stage or step affects the input to the next. Additional inputs to the separation model can include the desired product stream compositions, the most recent process feed stream composition, and the fixed process pressures, temperatures, and flow rates.

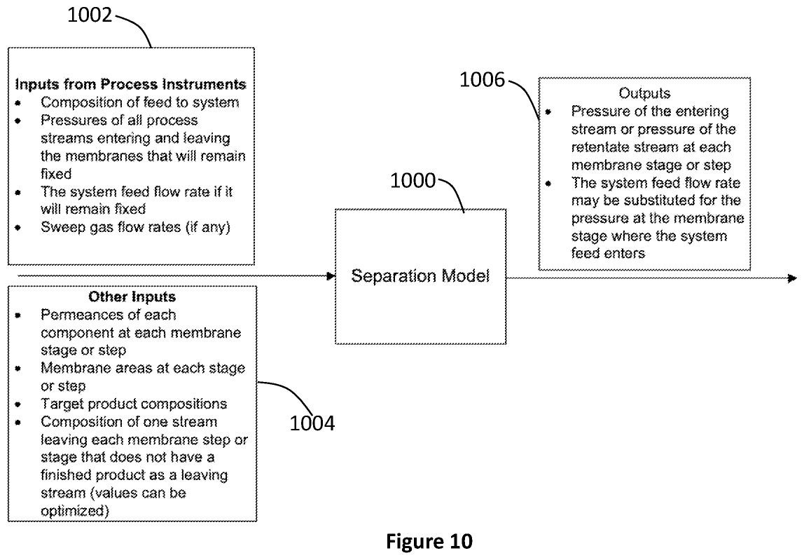

In summary, FIG. 10 shows an example of the inputs and outputs of the separation model 1000. The inputs 1002 comprise inputs from the process instruments, including composition of the feed to the system, pressures of all process streams entering and leaving the membrane that will remain fixed, the system feed flow rate if it will remain fixed, and sweep gas flow rate (if any). Additional inputs 1004 can include the permeances of each component at each membrane stage or step, membrane areas at each stage or step, target product compositions, and composition of one stream leaving each membrane step or stage that does not have a finished product as a leaving stream. Finally, the output 1006 can include pressure of the entering stream or pressure of the retentate stream at each membrane stage or step. The system feed flow rate may be substituted for the pressure at the membrane stage where the system feed enters. The separation model can be applied to the overall separation process.

Numerous embodiments of the composition control algorithm and system architecture described herein are possible. For example, the iterative membrane performance parameters calculation can be eliminated where the performance parameters calculated directly from the OMPPM (e.g., without further adjustment). Second, fixed membrane performance parameters can be used in place of the dynamic membrane performance parameters models. In this case, one can manually adjust the membrane performance parameters during operation of the control system, as one adjusts tuning constants on a PID controller. Third, a proportional control subroutine can be eliminated or replaced with another control approach. Fourth, the separation model used in the algorithm may be any type such as, log-mean or finite element. Fifth, the observed membrane performance parameters models may be any type such as, log-mean or finite element. Sixth, the empirical membrane performance parameters models may be any type that provides a good fit to measured membrane performance data collected under controlled conditions. Finally, without limitation, the GC can be replaced by some other device for measuring composition.

### Examples

### Example 1

Provided here is an example of an automated permeation process control system comprising a computing device. A computer software is operated by the computer, where the computer software includes a permeation model including permeance values for a separation membrane as a function of a feed gas concentration, pressure and flow rate. The computer software calculates setpoint adjustments for key process variables required to control product stream compositions within the desired ranges and communicates the setpoint adjustments to the controller.

The system includes a plurality of sensors for measuring system parameters. The sensors can include (a) a feed gas concentration sensor (e.g., as partial pressure to measure a feed gas concentration parameter); (b) a permeate gas concentration sensor to measure a permeate gas concentration parameter; (c) a retentate gas concentration sensor to measure a retentate gas concentration parameter; (d) a feed pressure sensor to measure a feed pressure parameter; (e) a permeate pressure sensor to measure a permeate pressure parameter; (f) a retentate pressure sensor to measure a permeate pressure parameter; (g) a feed flow rate sensor to measure a feed flow rate parameter; (h) a permeate flow rate sensor to measure a permeate flow rate parameter; (i) a retentate flow rate sensor to measure a retentate flow rate parameter; (j) a sweep gas flow rate sensor to measure a sweep gas flow rate parameter; (k) a separation membrane temperature sensor to measure a separation membrane temperature parameter; (l) a feed gas temperature sensor to measure a feed gas temperature parameter; (m) a sweep gas temperature sensor to measure a sweep gas temperature parameter; (n) a feed gas humidity sensor to measure a feed gas humidity parameter; (o) a sweep gas humidity sensor to measure a sweep gas humidity parameter; and (p) a controller that changes the one or more of the system parameters to increase a permeation rate of the permeate gas through the separation membrane. A heater can heat the separation membrane. An air moving device (e.g., fan) can increase the sweep gas flow rate.

This system can be used to perform a method of (automatically) controlling a permeation process. The method can include providing a test separation membrane having a separation membrane composition; measuring a first permeation rate through the test separation membrane for a permeate gas at a first feed gas flow rate, for a first feed gas, and a first partial pressure of the permeate gas in the first feed gas; measuring a second permeation rate through the test separation membrane for the permeate gas at second feed gas flow rate, for a second feed gas, and a second partial pressure of the permeate gas in the first feed gas (In some cases, the feed gas is constant and the flow rate and/or partial pressures are changed to get a curve. In some instances, other factors such as temperature or humidity are included in the model); and calculating a permeance value for the test separation membrane for each of the first feed gas and the second feed gas and creating a permeation model for the separation membrane composition.

The method can include providing a computer and a computer software that is operated by the computer, where the computer software includes the permeation model including modeled permeance values for the separation membrane as a function of a permeate gas concentration; providing a plurality of sensors for measuring system parameters, the sensors comprising: (a) a feed side permeate gas concentration sensor (e.g., partial pressure to measure a feed side permeate gas concentration parameter); (b) a permeate side permeate gas concentration sensor to measure a permeate side permeate gas concentration parameter; (c) a feed side pressure sensor to measure a feed side pressure parameter; (d) a permeate side pressure sensor to measure a permeate side pressure parameter; (e) a feed flow rate sensor to measure a feed flow rate parameter; (f) a sweep gas flow rate sensor to measure a sweep gas flow rate parameter; (g) a separation membrane temperature sensor to measure a separation membrane temperature parameter; (h) a feed gas temperature sensor to measure a feed gas temperature parameter; (i) a sweep gas temperature sensor to measure a sweep gas temperature parameter; (j) a feed gas humidity sensor to measure a feed gas humidity parameter; and (k) a sweep gas humidity sensor to measure a sweep gas humidity parameter.

The method can include providing a controller that is configured to change the one or more of the system parameters to increase a permeation rate of the permeate gas through the separation membrane; configuring a system separation membrane having substantially a system separation membrane composition that is substantially the same as the test separation membrane composition into a separation assembly (e.g., similar chemistry, similar equivalent weight) producing the feed gas flow into the membrane separation system and producing a sweep gas flow into the permeate sides of the separation membranes in the system; operating the computer program on the computer and monitoring system parameters to provide input to the computer program; and changing one or more of the system parameters to increase a permeation rate of the permeate gas through the separation membrane.

Additional controller features can include a heater to heat the separation membrane, or air moving device to increase the sweep gas flow rate, etc. The controller can change the parameters by providing instructions to the devices.

The hardware can be connected to the process to monitor process parameters where such hardware can include any device for composition measurement (e.g., a gas chromatograph), pressure sensors, temperature sensors, and flow meters, all of which are capable of communicating process data to the computer or PLC. The hardware can be connected to the process to adjust key process parameters where such hardware can include flow control valves, pressure control valves, heat input systems, all of which are capable of accepting command signals from the PLC or the computer.

The control algorithm and software for execution can reside in the computer memory. In some cases, the control algorithm and software for execution reside in the PLC memory. The control algorithm can include a stream composition error calculation, a proportional setpoint adjustment subroutine, an observed membrane performance parameters model, a separation model, and an empirical membrane performance model. The control algorithm can calculate setpoint adjustments for key process variables required to control product stream compositions within the desired ranges and communicates the setpoint adjustments to the PLC. The control algorithm can include an iterative solution procedure to converge calculated membrane performance parameters and calculated process variables to constant values. The observed membrane performance parameters model can utilize a log-mean pressure difference for calculating the transport rate driving force across the membrane. The separation model can utilize a log-mean pressure difference for calculating the transport rate driving force across the membrane. The empirical membrane performance parameters model can include equations for prediction of the membrane performance parameters (e.g., as power functions).

In some cases, a coordinate transformation can be used to adjust the empirical membrane performance model so that the membrane performance parameters predicted by it match the membrane performance parameters calculated by the observed membrane performance model at the observed operating conditions in order to compensate for membrane performance changes due to use.

### Example 2

Table 1a-1c shows an example of control algorithm execution for a two-stage separation process for propylene and propane following a sudden change in the composition of the feed to the separation process. The target compositions of the two product streams are 95 mol % propylene and 95 mol % propane, on a dry measurement basis. The product compositions are controlled by adjustment of the feed pressures at each membrane stage and the feed flow rate to the separation process is constant. Table 1a-1c summarizes the key process parameters (that are inputs to the control algorithm) and the control algorithm output values. Row 1 of the table reports the key process parameters at the initial feed composition, 60 mol % propylene. The feed pressure at both membrane stages is 200 psia. Row 2 reports the changes in the key process parameters after the feed composition changes to 50 mol % propylene. The propylene rich stream purity changes to 93% and the propane rich stream purity changes to 97%. Row 3 reports the values of the membrane performance parameters calculated by the OMPPM from the new process parameters. The separation model then takes these membrane performance parameters as inputs along with other process parameters and calculates new feed pressures at the two stages of the process that are required to bring the product stream compositions back to the target values. The EMPPM then utilizes the new pressures as inputs along with other calculated process parameters to calculate updated membrane performance parameters (presented in row 5). These updated membrane performance parameters are then used as inputs in a second iteration of the separation model. The process repeats until the membrane performance parameters and feed pressures at the two stages converge to constant values. Once execution of the control algorithm is completed, the new pressure setpoints are communicated to the PLC.

TABLE 1a
Control Algorithm Response to a Change in Feed Concentration -
Key Process Parameters and Model Input Values.

| | | System | Stage 1 | Stage 2 | | |
|---|---|---|---|---|---|---|
| | | Feed | Feed | Feed | | |
| | | Propylene | Propylene | Propylene | Stage 1 | Stage 2 |
| | | Mole | Mole | Mole | Flow | Flow |
| Row | Item Description | Fraction | Fraction | Fraction | Parameter | Parameter |
| 1 | Before Composition Change | 0.600 | 0.555 | 0.762 | 0.622 | 1.798 |
| 2 | After Composition Change | 0.500 | 0.456 | 0.694 | 0.616 | 1.606 |
| 3 | OMPPM | 0.500 | 0.456 | 0.694 | 0.616 | 1.606 |
| 4 | Separation Model | 0.500 | 0.492 | 0.736 | 0.652 | 1.711 |
| 5 | EMPPM | 0.500 | 0.492 | 0.736 | 0.652 | 1.711 |
| 6 | Separation Model Iteration 2 | 0.500 | 0.480 | 0.733 | 0.626 | 1.605 |
| 7 | EMPPM Interation 2 | 0.500 | 0.480 | 0.733 | 0.626 | 1.605 |
| 8 | Separation Model Iteration 3 | 0.500 | 0.480 | 0.735 | 0.624 | 1.595 |
| 9 | EMPPM Interation 3 | 0.500 | 0.480 | 0.735 | 0.624 | 1.595 |
| 10 | Separation Model Iteration 4 | 0.500 | 0.480 | 0.736 | 0.622 | 1.590 |

TABLE 1b
Control Algorithm Response to a Change in Feed Concentration -
Key Process Parameters and Model Input Values (continued)

| | | | | | | | | Stage 1 | Stage 2 |
|---|---|---|---|---|---|---|---|---|---|
| | | Stage 1 | Stage 1 | Stage 2 | Stage 2 | Stage 1 | Stage 2 | Product | Product |
| | | Propylene | Propylene/ | Propylene | Propylene/ | Feed | Feed | Propane | Propylene |
| | | Permeance | Propane | Permeance | Propane | Pressure | Pressure | Mole | Mole |
| Row | Item Description | (GPU) | Selectivity | (GPU) | Selectivity | (psia) | (psia) | Fraction | Fraction |
| 1 | Before Composition Change | 36.0 | 12.5 | 38.0 | 14.3 | 200 | 200 | 0.95 | 0.95 |
| 2 | After Composition Change | | | | | 200 | 200 | 0.97 | 0.93 |
| 3 | OMPPM | | | | | 200 | 200 | 0.97 | 0.93 |
| 4 | Separation Model | 38.7 | 12.8 | 38.7 | 14.2 | | | 0.95 | 0.95 |
| 5 | EMPPM | | | | | 191 | 161 | 0.95 | 0.95 |
| 6 | Separation Model Iteration 2 | 38.6 | 13.1 | 41.4 | 16.1 | | | 0.95 | 0.95 |
| 7 | EMPPM Interation 2 | | | | | 184 | 161 | 0.95 | 0.95 |
| 8 | Separation Model Iteration 3 | 39.3 | 13.3 | 41.1 | 15.9 | | | 0.95 | 0.95 |
| 9 | EMPPM Interation 3 | | | | | 182 | 161 | 0.95 | 0.95 |
| 10 | Separation Model Iteration 4 | 39.4 | 13.4 | 41.0 | 15.9 | | | 0.95 | 0.95 |

TABLE 1c
Control Algorithm Response to a Change in Feed Concentration - Output Values

| | | Stage 1 | Stage 1 | Stage 2 | Stage 2 | Stage 1 | Stage 2 |
|---|---|---|---|---|---|---|---|
| | | Propylene | Propylene/ | Propylene | Propylene/ | Feed | Feed |
| | | Permeance | Propane | Permeance | Propane | Pressure | Pressure |
| Row | Item Description | (GPU) | Selectivity | (GPU) | Selectivity | (psia) | (psia) |
| 1 | Before Composition Change | | | | | | |
| 2 | After Composition Change | | | | | | |
| 3 | OMPPM | 38.7 | 12.8 | 38.7 | 14.2 | | |
| 4 | Separation Model | | | | | 191 | 161 |
| 5 | EMPPM | 38.6 | 13.1 | 41.4 | 16.1 | | |
| 6 | Separation Model Iteration 2 | | | | | 184 | 161 |
| 7 | EMPPM Interation 2 | 39.3 | 13.3 | 41.1 | 15.9 | | |
| 8 | Separation Model Iteration 3 | | | | | 182 | 161 |
| 9 | EMPPM Interation 3 | 39.4 | 13.4 | 41.0 | 15.9 | | |
| 10 | Separation Model Iteration 4 | | | | | 181 | 161 |

What is claimed is:

1. A method for controlling a membrane-based separation process, the method comprising, by one or more computing devices:
a. receiving a product concentration, which product is produced by a process comprising a membrane separation, which process is operated at a first set of operating conditions;
b. optionally calculating a membrane performance parameter based at least in part on the first set of operating conditions;
c. calculating a second set of operating conditions based at least in part on the membrane performance parameter and a model of the process, such that operation of the process at the second set of operating conditions is expected to produce the product within a desired concentration range; and
d. communicating the second set of operating conditions to the process.

2. The method of claim 1, wherein the membrane performance parameter is calculated.

3. The method of claim 1, wherein the membrane performance parameter is fixed.

4. The method of claim 3, wherein the membrane performance parameter is capable of being adjusted.

5. The method of claim 1, wherein process data is also received and used at least in part to calculate the membrane performance parameter.

6. The method of claim 1, wherein the process data comprises a temperature, a pressure, a flow rate, or any combination thereof.

7. The method of claim 1, wherein the operating conditions comprise a valve setting, a pressure set point, a temperature set point, or any combination thereof.

8. The method of claim 1, wherein the membrane performance parameter comprises a permeance, a selectivity, or any combination thereof.

9. The method of claim 1, wherein the process comprises a plurality of membranes, and a membrane performance parameter is calculated for each of the plurality of membranes.

10. The method of claim 1, wherein the process comprises a plurality of membranes, and a composite membrane performance parameter is calculated for the plurality of membranes as a group.

11. The method of claim 1, wherein the model of the process includes an active membrane area for each membrane or group of membranes in the process.

12. The method of claim 1, wherein the membrane performance parameter is predicted at least in part (i) based on a set of operating conditions and (ii) based on the received process data.

13. The method of claim 1, wherein a correction factor is calculated and used to adjust the second set of operating conditions.

14. The method of claim 1, wherein the membrane performance parameter is predicted at least in part based on a set of operating conditions.

15. The method of claim 14, wherein the set of operating conditions are calculated by a separation model.

16. The method of claim 14, wherein the membrane performance parameter is associated with changes in a set of operating conditions.

17. The method of claim 14, wherein the membrane performance parameter is calculated using a power law function fit to the operating conditions and/or the received process data.

18. The method of claim 1, wherein the membrane performance parameter is calculated based at least in part on the received process data and the membrane area.

19. The method of claim 18, wherein the received process data includes temperatures, pressures, compositions, and flow rates of any stream entering or leaving the membrane.

20. The method of claim 18, wherein the membrane performance parameter is associated with aging of the membrane.

21. The method of claim 18, wherein the membrane performance parameter is calculated based at least in part on transport rate equations for a component in a process stream, a mass balance, and a predicted pressure drop.

22. The method of claim 18, wherein the transport rate equations are averaged or integrated over the membrane surface, optionally using a transport driving force calculated using a log-mean or finite element method.

23. The method of claim 1, wherein the second set of operating conditions is calculated based at least in part using transport rate equations for a component in a process stream, a mass balance, and a predicted pressure drop.

24. The method of claim 23, wherein a plurality of membrane separations are calculated simultaneously.

25. The method of claim 1, wherein the membrane performance parameter and/or the second set of operating conditions are not calculated if the received product concentration is within the desired concentration range.

26. The method of claim 1, further comprising, prior to calculating a membrane performance parameter, calculating a product composition error, which error is associated with a difference between the received product concentration and a desired product concentration.

27. The method of claim 1, wherein the membrane performance parameter is not calculated if the product composition error is less than a threshold error.

28. The method of claim 1, wherein the second set of operating conditions are calculated based at least in part on proportional adjustment of the first set of operating conditions if the composition error is less than the threshold error.

29. The method of claim 1, further comprising (i) calculating a second membrane performance parameter based at least in part on the second set of operating conditions and (ii) calculating a third set of operating conditions based at least in part on the second membrane performance parameter and the model of the process.

30. The method of claim 1, further comprising iteratively calculating new membrane performance parameters and new sets of operating conditions, based on results of a previous iteration, until the membrane performance parameter converges on a value.

31. The method of claim 30, further comprising communicating to the process, the operating conditions that are calculated when the membrane performance parameter converges.

32. The method of claim 1, wherein the product concentration is measured by gas chromatography.

33. The method of claim 1, wherein the membrane separation comprises a facilitated transport membrane.

34. The method of claim 1, wherein the membrane performance parameters depend at least in part on the process conditions.

35. The method of claim 1, wherein the membrane performance parameters change over a lifetime of the membrane.

36. The method of claim 1, wherein the second set of operating conditions are communicated to a programmable logic controller (PLC).

37. The method of claim 1, wherein the PLC changes the position of a valve, changes a pressure, or changes a temperature of a portion of the process.

38. The method of claim 1, wherein the process data is received from the PLC.

39. A system for controlling a membrane-based separation process, the system comprising:
a. a membrane module of a separation process, which separation process is configured to enrich a product;
b. a detector configured to measure a concentration of the product;
c. a sensor configured to measure a process parameter associated with the process;
d. a controller configured to control an operating condition associated with the process; and
e. a computing device configured to:
i. receive a product concentration from the detector when the process is operated at a first set of operating conditions;
ii. optionally calculate a membrane performance parameter based at least in part on the first set of operating conditions;
iii. calculate a second set of operating conditions based at least in part on the membrane performance parameter and a model of the process, such that operation of the process at the second set of operating conditions is expected to produce the product within a desired concentration range; and
iv. communicate the second set of operating conditions to the controller.

40. The system of claim 39, wherein the membrane performance parameter is calculated.

41. The system of claim 39, wherein the membrane performance parameter is fixed.

42. The system of claim 41, wherein the membrane performance parameter is capable of being adjusted.

43. The system of claim 39, wherein process data is also received by the computing device and used at least in part to calculate the membrane performance parameter.

44. The system of claim 39, wherein the process data comprises a temperature, a pressure, a flow rate, or any combination thereof.

45. The system of claim 39, wherein the operating conditions comprise a valve setting, a pressure set point, a temperature set point, or any combination thereof.

46. The system of claim 39, wherein the membrane performance parameter comprises a permeance, a selectivity, or any combination thereof.

47. The system of claim 39, wherein the process comprises a plurality of membranes, and a membrane performance parameter is calculated for each of the plurality of membranes.

48. The system of claim 39, wherein the process comprises a plurality of membranes, and a composite membrane performance parameter is calculated for the plurality of membranes as a group.

49. The system of claim 39, wherein the model of the process includes an active membrane area for each membrane or group of membranes in the process.

50. The system of claim 39, wherein the membrane performance parameter is predicted at least in part (i) based on a set of operating conditions and (ii) based on the received process data.

51. The system of claim 39, wherein a correction factor is calculated and used to adjust the second set of operating conditions.

52. The system of claim 39, wherein the membrane performance parameter is predicted at least in part based on a set of operating conditions.

53. The system of claim 52, wherein the set of operating conditions are calculated by a separation model.

54. The system of claim 52, wherein the membrane performance parameter is associated with changes in a set of operating conditions.

55. The system of claim 52, wherein the membrane performance parameter is calculated using a power law function fit to the operating conditions and/or the received process data.

56. The system of claim 39, wherein the membrane performance parameter is calculated based at least in part on the received process data and the membrane area.

57. The system of claim 56, wherein the received process data includes temperatures, pressures, compositions, and flow rates of any stream entering or leaving the membrane.

58. The system of claim 56, wherein the membrane performance parameter is associated with aging of the membrane.

59. The system of claim 56, wherein the membrane performance parameter is calculated based at least in part on transport rate equations for a component in a process stream, a mass balance, and a predicted pressure drop.

60. The system of claim 56, wherein the transport rate equations are averaged or integrated over the membrane surface, optionally using a transport driving force calculated using a log-mean or finite element method.

61. The system of claim 39, wherein the second set of operating conditions is calculated based at least in part using transport rate equations for a component in a process stream, a mass balance, and a predicted pressure drop.

62. The system of claim 61, wherein a plurality of membrane separations are calculated simultaneously.

63. The system of claim 39, wherein the membrane performance parameter and/or the second set of operating conditions are not calculated if the received product concentration is within the desired concentration range.

64. The system of claim 39, further comprising, prior to calculating a membrane performance parameter, calculating a product composition error, which error is associated with a difference between the received product concentration and a desired product concentration.

65. The system of claim 39, wherein the membrane performance parameter is not calculated if the product composition error is less than a threshold error.

66. The system of claim 39, wherein the second set of operating conditions are calculated based at least in part on proportional adjustment of the first set of operating conditions if the composition error is less than the threshold error.

67. The system of claim 39, further comprising (i) calculating a second membrane performance parameter based at least in part on the second set of operating conditions and (ii) calculating a third set of operating conditions based at least in part on the second membrane performance parameter and the model of the process.

68. The system of claim 39, further comprising iteratively calculating new membrane performance parameters and new sets of operating conditions, based on results of a previous iteration, until the membrane performance parameter converges on a value.

69. The system of claim 68, further comprising communicating to the process, the operating conditions that are calculated when the membrane performance parameter converges.

70. The system of claim 39, wherein the product concentration is measured by gas chromatography.

71. The system of claim 39, wherein the membrane separation comprises a facilitated transport membrane.

72. The system of claim 39, wherein the membrane performance parameters depend at least in part on the process conditions.

73. The system of claim 39, wherein the membrane performance parameters change over a lifetime of the membrane.

74. The system of claim 39, wherein the second set of operating conditions are communicated to a programmable logic controller (PLC).

75. The system of claim 39, wherein the PLC changes the position of a valve, changes a pressure, or changes a temperature of a portion of the process.

76. The system of claim 39, wherein the process data is received from the PLC.
